(19) United States
(12) Patent Application Publication
(10) Pub. No.: US 2026/0321754 A1
(43) Pub. Date: Oct. 15, 2026

(54) APPARATUS AND METHOD FOR INSPECTING POUCH CELL

(71) Applicant: SK ON CO., LTD., Seoul (KR)

(72) Inventors: Tae Gyun KIM, Daejeon (KR); Hyun Chul MA, Daejeon (KR); Ung Bae PARK, Daejeon (KR); Eun Taek OH, Daejeon (KR); Byoung Hak LEE, Daejeon (KR); Jung Soo CHANG, Daejeon (KR)

(21) Appl. No.: 19/642,638

(22) Filed: Apr. 9, 2026

(30) Foreign Application Priority Data
Apr. 10, 2025 (KR) 10-2025-0046968

(51) Int. Cl. H01M 10/42; G01J 1/42; G01J 1/44

(52) U.S. Cl. CPC H01M 10/4285; G01J 1/429; G01J 1/44; H01M 10/4228

(57) ABSTRACT

An apparatus for inspecting whether an aluminum layer is exposed in a pouch cell or a battery module including a plurality of stacked pouch cells according to an embodiment of the present disclosure may include at least one contact part configured to contact a cut surface of a sealing portion of the pouch cell and be electrically connected to the aluminum layer, a photon irradiator configured to irradiate photons toward a surface of the pouch cell to induce a photoelectric effect in the aluminum layer when the aluminum layer is exposed, and a controller including a determination unit configured to read an electrical signal generated when electrons emitted from the aluminum layer by the photoelectric effect are transmitted through the at least one contact part, and determine whether the aluminum layer is exposed based on the read electrical signal.

### CROSS-REFERENCE TO RELATED APPLICATION

This application claims priority to Korean Patent Application No. 10-2025-0046968 filed Apr. 10, 2025, the disclosure of which is hereby incorporated by reference in its entirety.

### BACKGROUND

### Technical Field

The present disclosure relates to an apparatus and method for inspecting a pouch cell to determine whether an aluminum layer of the pouch cell is exposed.

### Technical Considerations

Secondary batteries are widely used in various electronic devices, electric vehicles, and energy storage systems (ESS), and the demand therefor is continuously increasing. Among them, pouch-type secondary batteries, namely pouch cells, which can simultaneously achieve high energy density and light weight, are receiving significant attention.

These pouch cells generally use an aluminum laminate film as an exterior material, and an aluminum layer may be exposed to the outside due to physical damage or thermal and mechanical stress during a manufacturing process or a module assembly process. When the aluminum layer is exposed to the outside, contact with moisture or an electrolyte accelerates corrosion of the aluminum layer, which may degrade the durability and safety of the battery.

### SUMMARY

Embodiments of the present disclosure may provide an apparatus and method for inspecting a pouch cell, capable of inspecting whether an aluminum layer is exposed to the outside in a non-contact manner during a manufacturing and assembly process of the pouch cell or a battery module.

According to an embodiment of the present disclosure, there is provided an apparatus for inspecting whether an aluminum layer is exposed in a pouch cell or a battery module including a plurality of stacked pouch cells, the apparatus comprising: at least one contact part configured to contact a cut surface of a sealing portion of the pouch cell and be electrically connected to the aluminum layer; a photon irradiator configured to irradiate photons toward a surface of the pouch cell to induce a photoelectric effect in the aluminum layer when the aluminum layer is exposed; and a controller including a determination unit configured to read an electrical signal generated when electrons emitted from the aluminum layer by the photoelectric effect are transmitted through the at least one contact part, and determine whether the aluminum layer is exposed based on the read electrical signal.

In some non-limiting embodiments, the at least one contact part may comprise at least one contact unit disposed to correspond to the cut surface of the sealing portion; and an elastic conductive part formed at a front end of each contact unit and electrically connected to the aluminum layer.

In some non-limiting embodiments, the elastic conductive part may comprise a conductive rubber elastically contacting the cut surface of the sealing portion; a contact pin pressed by the conductive rubber to be electrically connected to the aluminum layer; and a support plate accommodating the conductive rubber and the contact pin, providing a moving space for the conductive rubber and the contact pin, and supporting the conductive rubber and the contact pin.

In some non-limiting embodiments, the at least one contact unit may be connected to a position controller configured to adjust a position and an angle of the elastic conductive part such that the elastic conductive part is oriented in a direction facing the corresponding cut surface of the sealing portion.

In some non-limiting embodiments, the photon irradiator may comprise a light source configured to generate photons having an Extreme Ultraviolet (EUV) wavelength; and a transfer unit configured to transfer the light source along an upper portion of the pouch cell or the battery module.

In some non-limiting embodiments, the determination unit may comprise logic configured to read a voltage or current value of the electrical signal transmitted through the at least one contact part; and determine that the aluminum layer is exposed to the outside when the electrical signal is equal to or greater than a reference threshold.

In some non-limiting embodiments, the controller may be further configured to output the read electrical signal to a user interface; and identify and display a location where exposure of the aluminum layer is suspected.

According to another embodiment of the present disclosure, there is provided a method for inspecting whether an aluminum layer is exposed in a pouch cell or a battery module including a plurality of stacked pouch cells, the method comprising: disposing a contact part configured to contact a cut surface of a sealing portion of the pouch cell and be electrically connected to the aluminum layer; inducing a photoelectric effect in the aluminum layer when the aluminum layer is exposed, by irradiating photons toward a surface of the pouch cell; reading an electrical signal generated when electrons emitted from the aluminum layer by the photoelectric effect are transmitted through the contact part; and determining whether the aluminum layer is exposed based on the electrical signal.

In some non-limiting embodiments, the contact part may comprise at least one contact unit disposed to correspond to the cut surface of the sealing portion; and an elastic conductive part formed at a front end of each contact unit and electrically connected to the aluminum layer.

In some non-limiting embodiments, the elastic conductive part may comprise a conductive rubber elastically contacting the cut surface of the sealing portion; a contact pin pressed by the conductive rubber to be electrically connected to the aluminum layer; and a support plate accommodating and supporting the conductive rubber and the contact pin.

In some non-limiting embodiments, the at least one contact unit may be connected to a position controller configured to adjust a position and an angle of the elastic conductive part such that the elastic conductive part is oriented in a direction facing the cut surface of the sealing portion.

In some non-limiting embodiments, inducing the photoelectric effect in the aluminum layer may comprise generating the photons using a light source having an Extreme Ultraviolet (EUV) wavelength; and transferring the light source along an upper portion of the pouch cell or the battery module using a transfer unit.

In some non-limiting embodiments, determining whether the aluminum layer is exposed may comprise determining that the aluminum layer is exposed to the outside when the electrical signal is equal to or greater than a reference threshold.

In some non-limiting embodiments, an apparatus and method for inspecting a pouch cell capable of determining whether an aluminum layer of the pouch cell or a battery module is exposed in a non-contact manner, thereby detecting manufacturing defects in advance, may be provided.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a block diagram illustrating an apparatus for inspecting a pouch cell according to some non-limiting embodiments or aspects according to the principles of the present disclosure.

FIG. 2 is a schematic diagram illustrating a cross-sectional structure of a pouch film according to some non-limiting embodiments or aspects according to the principles of the present disclosure.

FIG. 3 is a conceptual diagram illustrating a photoelectric effect caused by EUV light irradiation when an aluminum layer is exposed in a pouch film according to some non-limiting embodiments or aspects according to the principles of the present disclosure.

FIG. 4 is a schematic diagram illustrating an apparatus for inspecting a pouch cell in a battery module according to some non-limiting embodiments or aspects according to the principles of the present disclosure.

FIG. 5 is a schematic diagram illustrating an apparatus for inspecting a single pouch cell according to some non-limiting embodiments or aspects according to the principles of the present disclosure.

FIG. 6A is a schematic diagram illustrating a state before a contact unit approaches a cut surface of a sealing portion according to some non-limiting embodiments or aspects according to the principles of the present disclosure.

FIG. 6B is a schematic diagram illustrating a state in which a contact unit is in contact with a cut surface of a sealing portion according to some non-limiting embodiments or aspects according to the principles of the present disclosure.

FIG. 7 is a flowchart illustrating a method for inspecting a pouch cell according to some non-limiting embodiments or aspects according to the principles of the present disclosure.

### DETAILED DESCRIPTION

Hereinafter, embodiments or aspects will be described in detail with reference to the accompanying drawings. However, since various changes may be made in the embodiments or aspects, the scope of the patent disclosure is not limited or restricted by these embodiments or aspects. It should be understood that all modifications, equivalents, and alternatives for the embodiments or aspects are comprised in the scope of the present disclosure. For example, it is to be understood that the present disclosure may assume various alternative variations and step sequences, except where expressly specified to the contrary. It is also to be understood that the specific devices and processes illustrated in the attached drawings, and described in the following detailed description, are simply exemplary and non-limiting embodiments or aspects of the disclosed subject matter. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “comprise”, “comprises”, “comprising”, “include”, “includes”, “including”, “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

It will be understood that when a component is described as being “connected,” “combined” or “coupled” to another component, the component may be directly connected or coupled to the another component, but it may be “connected,” “combined” or “coupled” to the another component by an intervening another component that may be present.

Further, in describing the components of the embodiment or aspect, the meaning of “or” may mean each of the components, may mean two or more of the components, or may mean all of the components. For example, it should be understood that the expressions “a, b or c” represent any one of “a,” “b,” “c,” “a and b,” “a and c,” “b and c,” and “a, b and c.”

Components comprised in one embodiment or aspect and components comprising common functions will be described using the same names in other embodiments or aspects. The description given in one embodiment or aspect may be applied to other embodiments or aspects, and therefore will not be described in detail within the overlapping range, unless there is a description opposite thereto.

The device and/or ‘data’ processed by the device may be expressed in terms of ‘information”. Here, the information may be used as a concept comprising the data.

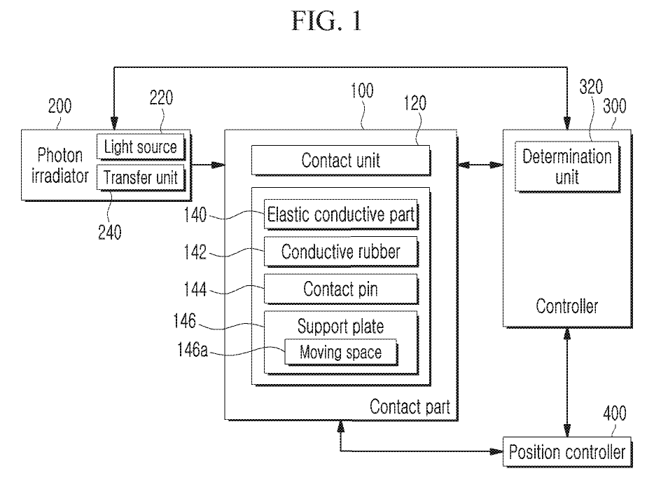

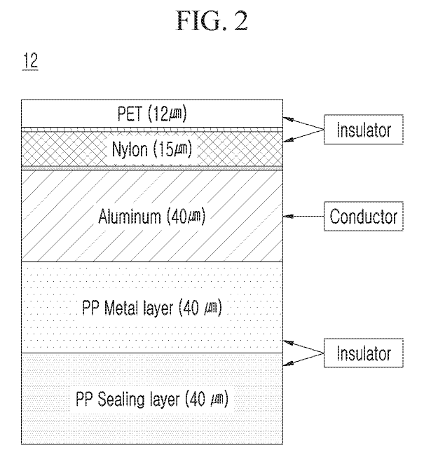

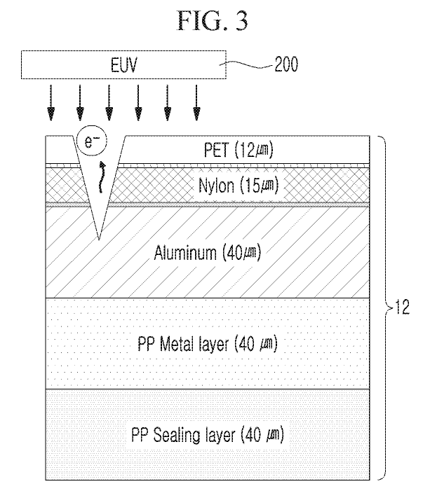

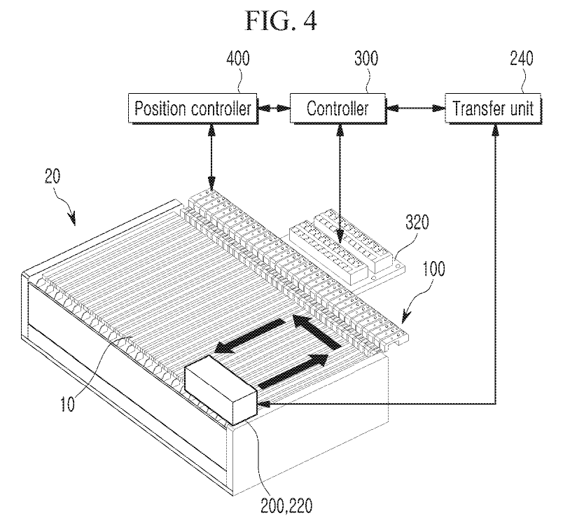

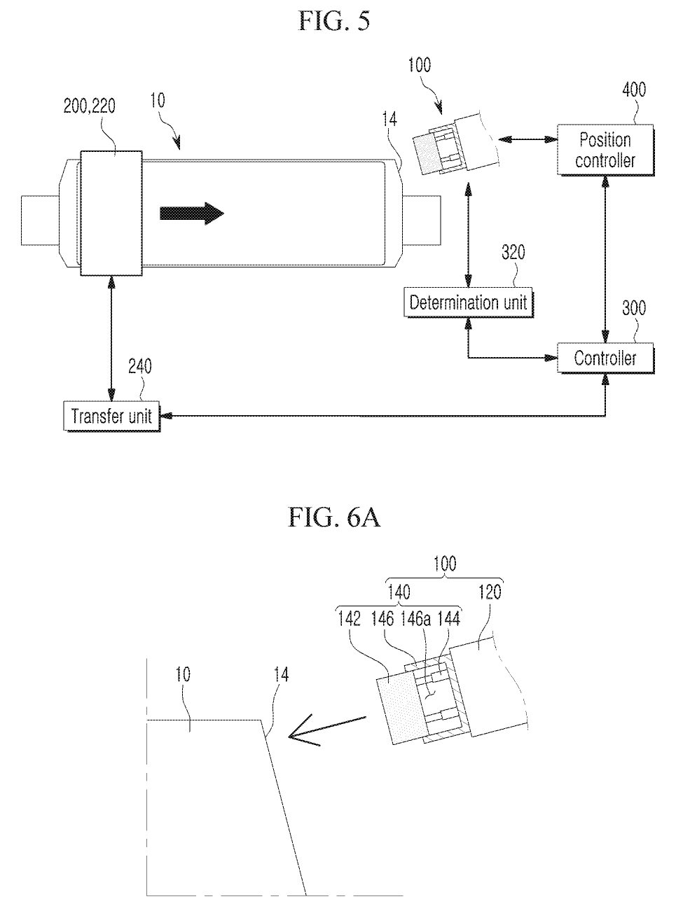

FIG. 1 is a block diagram illustrating an apparatus for inspecting a pouch cell according to an embodiment of the present disclosure. FIG. 2 is a schematic diagram illustrating a cross-sectional structure of a pouch film. FIG. 3 is a conceptual diagram illustrating a photoelectric effect caused by Extreme Ultraviolet (EUV) light irradiation when an aluminum layer is exposed in a pouch film. FIG. 4 is a schematic diagram illustrating an apparatus for inspecting a pouch cell in a battery module according to an embodiment of the present disclosure. FIG. 5 is a schematic diagram illustrating an apparatus for inspecting a single pouch cell according to an embodiment of the present disclosure.

Referring to FIGS. 1 to 5, an apparatus for inspecting a pouch cell according to an embodiment of the present disclosure is an apparatus for inspecting whether an aluminum layer is exposed in a pouch cell 10 or a battery module 20 including a plurality of stacked pouch cells 10. The apparatus may include at least one contact part 100 configured to contact a cut surface 14 of a sealing portion of the pouch cell 10 and be electrically connected to the aluminum layer, a photon irradiator 200 configured to irradiate photons toward a surface of the pouch cell 10 to induce a photoelectric effect in the aluminum layer when the aluminum layer is exposed, and a controller 300 including a determination unit 320 configured to read an electrical signal generated when electrons emitted from the aluminum layer by the photoelectric effect are transmitted through the contact part 100, and determine whether the aluminum layer is exposed based on the read electrical signal.

Referring to FIGS. 2 and 3, the pouch cell 10 according to an embodiment of the present disclosure has a structure sealed by a film 12 including an aluminum layer, and an electrode assembly and an electrolyte may be accommodated therein.

Referring to FIGS. 4 and 5, a plurality of pouch cells 10 may be stacked to form the battery module 20, and the cut surface 14 of the sealing portion formed by folding or sealing may exist on an outside of the pouch cell 10. The cut surface 14 of the sealing portion is a cross-section cut or trimmed after charging, and is a portion where the aluminum layer, which is an internal conductive layer, may be exposed to the outside.

Referring to FIGS. 2 and 3, the film 12 forms a multilayer structure (insulator/conductor/insulator) including a PET layer, a Nylon layer, an Aluminum layer, a PP Metal layer, and a PP Sealing layer from a top thereof, and among them, the aluminum layer is a conductive metal layer and may serve as a conductor.

When the aluminum layer is exposed to the outside due to an external impact or an abnormality in a trimming process, there is a risk of electrical leakage or corrosion. Thus, the present disclosure intends to accurately determine whether the aluminum layer is exposed.

According to various embodiments of the present disclosure, it is possible to determine whether the aluminum layer of the pouch cell 10 is exposed in the battery module 20 in which the plurality of pouch cells 10 are stacked, or to determine whether the aluminum layer is exposed in the single pouch cell 10.

Referring to FIGS. 4 and 5, the contact part 100 according to an embodiment of the present disclosure may directly contact the cut surface 14 of the sealing portion to be electrically connected to the aluminum layer. The contact part 100 may include at least one contact unit 120, and each contact unit 120 may be disposed at a position corresponding to the cut surface 14 of the sealing portion of the pouch cell 10.

The contact part 100 has a structure through which an electrical signal can flow, and when the aluminum layer emits electrons by the photoelectric effect, the contact part 100 may collect the emitted electrons and transmit them to the controller 300.

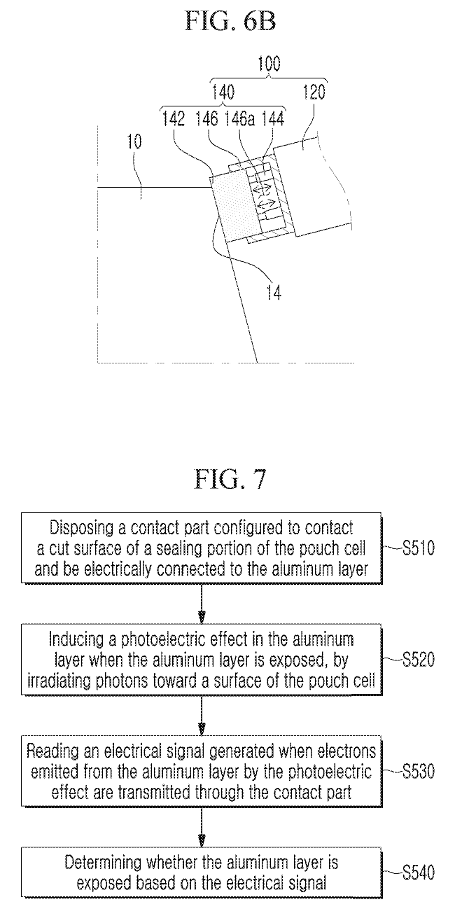

Referring to FIGS. 5, 6A, and 6B, the contact part 100 according to an embodiment of the present disclosure may be formed to be inclined so as to face the cut surface 14 of the sealing portion of the pouch cell 10. Accordingly, when the aluminum layer is exposed to the outside, an electron flow may be stably transmitted through the contact part 100.

Referring to FIGS. 6A and 6B, the contact part 100 according to an embodiment of the present disclosure may include at least one contact unit 120 disposed to correspond to the cut surface 14 of the sealing portion, and an elastic conductive part 140 formed at a front end of each contact unit 120 and electrically connected to the aluminum layer.

The contact part 100 is electrically connected to the aluminum layer formed on the cut surface 14 of the sealing portion of the pouch cell 10, and may include a plurality of contact units 120 and the elastic conductive part 140.

In this case, each contact unit 120 is formed to correspond to a position of the cut surface 14 of the sealing portion arranged on an individual cell basis of the pouch cell 10 or at regular intervals, so that the number of contact units 120 can be adjusted according to the number of cells to be inspected.

Referring to FIGS. 4, 5, 6A, and 6B, the contact units 120 are arranged independently, thereby simultaneously inspecting a plurality of cells or a plurality of cells in a module (refer to FIG. 4), or inspecting a single pouch cell 10 (refer to FIG. 5).

A position and an angle with respect to the cut surface 14 of the sealing portion may be precisely adjusted under the control of the position controller 400 according to an embodiment of the present disclosure. Such an arrangement of the contact units 120 may be configured in a linear or modular form, and may be applied to various modified embodiments depending on an alignment state of the pouch cell 10 or a degree of automation of inspection equipment.

The elastic conductive part 140 may be disposed at the front end of each contact unit 120. The elastic conductive part 140 is in direct contact with the cut surface 14 of the sealing portion to form an electrical connection, and may be formed to be elastically deformable to correspond to an inclined surface or a step of the cut surface 14 of the sealing portion during a contact process.

The elastic conductive part 140 according to an embodiment of the present disclosure may be formed to be stably in close contact with the cut surface 14 of the sealing portion of the pouch cell 10. In particular, since the electron flow occurs only when the aluminum layer is exposed to the outside, the elastic conductive part 140 may be formed of a material having elastic restoring force so that an electrical connection can be maintained even with a minute contact difference.

As a result, an electrical connection between the contact part 100 and the aluminum layer existing on the cut surface 14 of the sealing portion of the pouch cell 10 is stably established, thereby stably collecting electrons emitted by the photoelectric effect. Therefore, the contact unit 120 and the elastic conductive part 140 can maintain a stable contact even with a shape deviation of the cut surface 14 of the sealing portion of the pouch cell 10. As a result, it is possible to improve read precision of the electrical signal and inspection reliability.

Referring to FIGS. 6A and 6B, the elastic conductive part 140 according to an embodiment of the present disclosure may include a conductive rubber 142 elastically contacting the cut surface 14 of the sealing portion, a contact pin 144 pressed by the conductive rubber 142 to be electrically connected to the aluminum layer, and a support plate 146 accommodating the conductive rubber 142 and the contact pin 144, providing a moving space 146a for the conductive rubber 142 and the contact pin 144, and supporting the conductive rubber 142 and the contact pin 144.

The elastic conductive part 140 according to an embodiment may include the conductive rubber 142 in direct contact with the cut surface 14 of the sealing portion. The conductive rubber 142 is capable of elastic deformation by an external stimulus and is formed of a material having excellent electrical conductivity, so that it can flexibly contact even an inclination or a curve of the cut surface 14 of the sealing portion of the pouch cell 10, thereby securing contact stability and maintaining an electrical connection with the aluminum layer.

The conductive rubber 142 can maintain a contact force even in repeated contact or detachment operations through an elastic restoring force, and prevents an electrical disconnection from occurring even if a minute step between cells or a mechanical error occurs.

A plurality of contact pins 144 may be disposed inside the conductive rubber 142 according to an embodiment of the present disclosure. The contact pin 144 may generally include a metal spring pin structure (e.g., a pogo-pin), and when pressed from the outside by the conductive rubber 142, the contact pin 144 may be more strongly in close contact with the cut surface 14 of the sealing portion to transmit an electrical signal.

In this case, while being supported by the restoring force of the conductive rubber 142, the contact pin 144 should be designed to be movable within a certain range, so that it can flexibly contact even a minute distortion or inclination that may occur in a manufacturing process or a module assembly state of the pouch cell 10.

The contact pin 144 according to an embodiment is generally formed of a nickel-plated copper pin or a stainless steel material, and a surface anti-oxidation treatment may be applied thereto.

The conductive rubber 142 and the contact pin 144 according to an embodiment may be accommodated in the support plate 146. The support plate 146 is a housing of the elastic conductive part 140, supports the conductive rubber 142 and the contact pin 144, and may include a moving space 146a therein. The moving space 146a may be set to accommodate a compressive deformation of the conductive rubber 142 and a linear movement of the contact pin 144. This provides an optimal gap to maintain responsiveness and restoring force of the entire structure.

The support plate 146 according to an embodiment may be formed of a metal frame, an insulating resin frame, or a composite material, and may provide structural stability to the entire contact unit 120.

Accordingly, the elastic conductive part 140 according to an embodiment of the present disclosure can more accurately contact the cut surface 14 of the sealing portion, thereby stably securing an electrical connection with the aluminum layer. As a result, it is possible to provide electrical reliability capable of transmitting electrons emitted by the photoelectric effect to a fixed path.

The contact unit 120 according to an embodiment of the present disclosure may be connected to the position controller 400 configured to adjust a position and an angle of the elastic conductive part 140 such that the elastic conductive part 140 is oriented in a direction facing the corresponding cut surface 14 of the sealing portion.

The apparatus for inspecting a pouch cell according to an embodiment of the present disclosure is applied to an inspection of a single pouch cell 10 or the battery module 20 in which a plurality of pouch cells 10 are stacked, and the cut surface 14 of the sealing portion of the pouch cell 10 may have a minute height difference or inclination. The elastic conductive part 140 may be oriented in a specific direction for a more accurate contact with the cut surface 14 of the sealing portion.

To this end, an embodiment of the present disclosure may additionally include the position controller 400. The position controller 400 is coupled to each contact unit 120, and may include a structure capable of adjusting a mounting position or an angle of the contact unit 120.

The position controller 400 may include, for example, a rotatable or slidable support frame, a cam structure, or a screw mechanism, and may adjust an inclination of the elastic conductive part 140 or a height of a front end portion thereof. For example, the position controller 400 may be implemented by a mechanical operation, a pneumatic control, or a motor control method.

Through the use of the position controller 400, the contact unit 120 may be disposed in a direction facing the cut surface 14 of the sealing portion of each pouch cell 10. In particular, as illustrated in FIGS. 6A and 6B, after the contact unit 120 is disposed in a horizontal or inclined position in a standby state before an inspection, a contact direction and an inclination may be adjusted according to the cut surface 14 of the sealing portion of the pouch cell 10 to enable a close contact operation. For this reason, even if a geometric shape of the cut surface 14 of the sealing portion is not constant, a front end of the conductive rubber 142 can always maintain a uniform contact force.

Accordingly, the apparatus for inspecting a pouch cell according to an embodiment of the present disclosure can flexibly correspond to the cut surface 14 of the sealing portion having various thicknesses, lengths, and shapes, and a close contact of the elastic conductive part 140 is possible.

The photon irradiator 200 according to an embodiment of the present disclosure is an apparatus for irradiating photons toward a surface of the pouch cell 10, and can induce a photoelectric effect when the irradiated photons reach the aluminum layer.

The photon irradiator 200 includes a light source 220 emitting photons having an Extreme Ultraviolet (EUV) wavelength, and the light source 220 can sequentially irradiate the photons onto the surface of each pouch cell 10 while being transferred by a transfer unit 240 at an upper portion of the pouch cell 10 or the battery module 20.

As illustrated in FIG. 3, the photon irradiator 200 induces the photoelectric effect when the photons are irradiated onto a portion where the aluminum layer is exposed to the outside, thereby emitting electrons. In particular, the EUV light is a wavelength having high energy, and can effectively generate the photoelectric effect in the aluminum layer which is a conductive metal.

The photon irradiator 200 according to an embodiment of the present disclosure may include a light source 220 configured to generate photons having an Extreme Ultraviolet (EUV) wavelength, and a transfer unit 240 configured to transfer the light source 220 along an upper portion of the pouch cell 10 or the battery module 20.

The EUV wavelength generally belongs to a short wavelength range of 10 to 121 nm, and has a characteristic of being able to pass through a film layer of the pouch cell 10 to reach the aluminum layer.

In an embodiment of the present disclosure, an EUV light source having a wavelength band of 13.5 nm may be particularly used, and in this case, a vacuum chamber structure may be included inside the light source to stably maintain an output of the light source in a high vacuum or semi-vacuum state.

For example, the light source 220 may be implemented in various forms such as an EUV laser, a pulsed plasma source, or an EUV lamp, and the selected light source can uniformly emit EUV photons having a certain intensity.

According to an embodiment, the photon irradiator 200 may include the transfer unit 240 configured to transfer the light source 220 along the upper portion of the pouch cell 10 or the battery module 20. The transfer unit 240 is configured to move the light source 220 in x-axis and y-axis directions, and may include, for example, a linear motor, an electric slide, a belt drive device, or a rail system. The transfer unit 240 may be interlocked with a control system capable of precise position control, so that the light source 220 can be aligned to correspond to an upper surface of each pouch cell 10, and can irradiate the photons while moving at a constant speed.

FIG. 4 is a schematic diagram illustrating an apparatus for inspecting a pouch cell in a battery module according to an embodiment of the present disclosure. FIG. 5 is a schematic diagram illustrating an apparatus for inspecting a single pouch cell according to an embodiment of the present disclosure.

Referring to FIGS. 4 and 5, the photon irradiator 200 may irradiate photons toward an upper surface (wide surface) or a side surface (narrow surface) of the pouch cell 10, and an irradiation angle or position is adjustable according to a shape of the disposed cell.

For example, in FIG. 4, the photon irradiator 200 may be installed along an upper region of the battery module 20, and may include a structure in which photons are irradiated in a direction facing the side surface of each pouch cell 10. Such a structure ensures that the photons can be irradiated without omission over the entire cell area, not limited to a position where the aluminum layer is exposed, and can increase inspection reliability.

FIG. 5 illustrates that the light source 220 is irradiated toward the upper surface of the pouch cell in the single pouch cell inspection.

Accordingly, the photon irradiator 200 according to an embodiment of the present disclosure can stably induce the photoelectric effect of the aluminum layer and simultaneously increase the efficiency of inspection time.

In particular, it is possible to improve the inspection accuracy for each cell in the battery module 20 having a stacked structure, and since an irradiation range and direction can be easily adjusted according to a cell position, it can be applied to various module structures.

The controller 300 according to an embodiment of the present disclosure includes a determination unit 320 to read the electrical signal received through the contact part 100, and determine that the aluminum layer is exposed to the outside when the corresponding signal is equal to or greater than a threshold.

The controller 300 may also be interlocked with the transfer unit 240 of the photon irradiator 200 and the position controller 400 to perform position control of the light source 220, adjustment of an irradiation position, or synchronization of measurement timing.

The determination unit 320 may analyze a voltage or current value of the received electrical signal in real time, and compare it with a reference threshold to determine whether the aluminum layer is exposed.

According to an embodiment, the controller 300 may be connected to a user interface, and may visually display a location where exposure of the aluminum layer is suspected or generate a warning.

The determination unit 320 according to an embodiment of the present disclosure may include logic configured to read a voltage or current value of the electrical signal transmitted through the contact part 100, and determine that the aluminum layer is exposed to the outside when the electrical signal is equal to or greater than a reference threshold.

The determination unit 320 may detect and analyze the electrical signal flowing in conjunction therewith when electrons emitted from the aluminum layer according to the photoelectric effect generated by the photons irradiated by the photon irradiator 200 are transmitted through the contact part 100.

Specifically, the determination unit 320 is configured to read the voltage value or the current value of the electrical signal received through the contact part 100 in real time, and the electrical signal detected at this time reflects the flow of electrons generated by the photoelectric effect. A magnitude or a pattern of such a signal may show a difference depending on whether the aluminum layer is exposed to the outside.

The determination unit 320 according to an embodiment stores a preset reference threshold, and the reference threshold may be experimentally set based on characteristics of electrical signals that may occur in an unexposed aluminum layer in a normal state and an exposed aluminum layer, respectively.

The threshold according to an embodiment of the present disclosure may be set to a level of 0.1 V based on voltage or tens of microamperes (μA) or more based on current, which may be set differently according to a material or a thickness of the aluminum layer of the actual pouch cell, an irradiation intensity of photons, or the like.

The determination unit 320 according to an embodiment compares the magnitude of the received electrical signal with the threshold, and if the detected signal is equal to or greater than the threshold, the determination unit 320 may determine that the aluminum layer formed at the corresponding location is exposed to the outside. Conversely, when it is less than the threshold, it may be determined that the aluminum layer is normally shielded by an insulating film or a protective layer.

Such a comparison and determination process may be automatically performed by internal logic or a software algorithm, and a threshold comparison method may be implemented in various ways, such as a comparison method based on a fixed value or an average value, or logic considering a temporal change rate.

The determination unit 320 according to an embodiment of the present disclosure may sequentially or in parallel analyze electrical signals for the plurality of pouch cells 10.

As illustrated in FIGS. 4 and 5, according to an embodiment of the present disclosure, the determination unit 320 may be directly connected to the contact part 100 to receive the electrical signal. This means that the determination is made as the electrons emitted along a conductive path in contact with the cut surface 14 of the sealing portion reach the determination unit 320.

As described above, according to an embodiment of the present disclosure, a case where the aluminum layer of the pouch cell 10 is exposed to the outside and a case where it is not can be determined by comparing them with quantitative values. Accordingly, according to an embodiment of the present disclosure, inspection reliability is high and whether there is a defect can be automatically sorted.

In addition, since the same standard can be repeatedly applied, consistency of inspection results can be maintained, and the determination result can be provided in real time through a user interface or recorded in a data storage device.

The controller 300 according to an embodiment of the present disclosure may output the read electrical signal to a user interface, and identify and display a location where exposure of the aluminum layer is suspected.

The controller 300 according to an embodiment includes the determination unit 320 to read a voltage value or a current value of the electrical signal transmitted through the contact part 100, and determine whether the aluminum layer is exposed to the outside when the signal is equal to or greater than a reference threshold.

The controller 300 may visualize and output such a determination result in real time through a user interface (UI). In an embodiment of the present disclosure, the user interface may be implemented in various forms such as a display, a monitor, a touch screen, or an LED indicator, and may display a result based on the electrical signal as a numerical value, a graph, a color code, or an icon.

The controller 300 according to an embodiment may identify a location where the exposure of the aluminum layer to the outside is suspected, based on the electrical signal value mapped to the position of each contact part 100, and visually highlight and display the identified location.

For example, the suspected exposure location may be displayed as a red icon or a warning mark, and a normal location may be displayed in green, thereby facilitating an inspector's intuitive identification. Such an output method may be implemented in a form matching an arrangement of individual cells or modules.

Referring to FIGS. 4 and 5, the controller 300 may receive signals from the at least one contact part 100 and the photon irradiator 200 in consideration of an arrangement form of the pouch cell 10 or the battery module 20, process the signals, and output a result for each cell.

Accordingly, according to an embodiment of the present disclosure, by providing a visual output in real time through the user interface, an inspector can quickly determine whether there is an abnormality without separate data interpretation.

As described above, the apparatus for inspecting a pouch cell according to an embodiment of the present disclosure can more accurately determine whether the aluminum layer of the pouch cell is exposed to the outside, and can perform continuous inspection at high speed. In addition, it is possible to determine whether the aluminum layer of the pouch cell is exposed in the battery module 20 as well as in the single pouch cell.

FIG. 7 is a flowchart illustrating a method for inspecting a pouch cell according to an embodiment of the present disclosure. In the method for inspecting a pouch cell according to an embodiment of the present disclosure, a description of a part overlapping with the above-described apparatus for inspecting a pouch cell will be omitted.

A method for inspecting a pouch cell according to an embodiment of the present disclosure is a method for inspecting whether an aluminum layer is exposed in a pouch cell or a battery module including a plurality of stacked pouch cells. The method includes disposing a contact part configured to contact a cut surface of a sealing portion of the pouch cell and be electrically connected to the aluminum layer (S510), inducing a photoelectric effect in the aluminum layer when the aluminum layer is exposed, by irradiating photons toward a surface of the pouch cell (S520), reading an electrical signal generated when electrons emitted from the aluminum layer by the photoelectric effect are transmitted through the contact part (S530), and determining whether the aluminum layer is exposed based on the electrical signal (S540).

The contact part 100 configured to contact the cut surface of the sealing portion of the pouch cell and be electrically connected to the aluminum layer is disposed (S510).

The pouch cell or the battery module including the plurality of stacked pouch cells, which is an inspection target, may be prepared, and at least one contact part may be disposed on the cut surface of the sealing portion of the corresponding pouch cell. The contact part 100 is in contact with the aluminum layer formed on the cut surface of the sealing portion to be electrically connected thereto, and may form a reception path for electrons emitted from the aluminum layer.

In an embodiment, a plurality of contact units may be arranged in parallel to correspond to an arrangement of the cut surface of the sealing portion, and each contact unit may include an elastic conductive part 140 at a front end thereof to maintain an electrical connection with the aluminum layer. The elastic conductive part 140 includes a conductive rubber 142 and a contact pin 144, and may be fixed by a support plate 146.

According to an embodiment of the present disclosure, the photoelectric effect is induced in the aluminum layer when the aluminum layer is exposed, by irradiating the photons toward the surface of the pouch cell (S520).

The photons may be irradiated toward an outer surface of the pouch cell by the photon irradiator 200. The photon irradiator 200 may include a light source 220 configured to generate photons having an Extreme Ultraviolet (EUV) wavelength, and a transfer unit 240 configured to transfer the light source along an upper portion of the pouch cell or the battery module.

The photons reach the surface of the pouch cell to induce the photoelectric effect in the aluminum layer when the aluminum layer is exposed to the outside. Accordingly, electrons are emitted from a metal surface of the aluminum layer, and the electrons move to an external circuit through the contact part electrically connected to the aluminum layer.

According to an embodiment of the present disclosure, the electrical signal generated when the electrons emitted from the aluminum layer by the photoelectric effect are transmitted through the contact part is read (S530).

The electrical signal generated when the electrons emitted from the aluminum layer by the photoelectric effect are transmitted through the contact part may be read. The electrical signal is received in a form of a voltage value or a current value, and the controller 300 may read and record it in real time.

Since a magnitude or a pattern of the electrical signal appears differently depending on whether the aluminum layer is exposed, the corresponding signal may be utilized as a determination reference.

According to an embodiment of the present disclosure, whether the aluminum layer is exposed is determined based on the electrical signal (S540).

The controller may determine that the aluminum layer is exposed to the outside when the signal is equal to or greater than a preset reference threshold by comparing it with the preset reference threshold, and may determine that the aluminum layer is not exposed when the signal is less than the reference threshold. Such a determination result may be visually output through a user interface or stored in a recording device to be utilized for future quality analysis.

As described above, the method for inspecting a pouch cell of the present disclosure can improve measurement precision and reliability by combining non-contact photon irradiation and electrical determination. In particular, since a parallel inspection is possible even in a structure in which a plurality of cells are modularized, it is possible to maintain inspection accuracy while saving time and cost.

The contents described above are merely examples applying the principles of the present disclosure, and other configurations may be further included without departing from the scope of the present invention. For example, at least some of the various embodiments of the present disclosure described above may be combined.

What is claimed is:

1. An apparatus for inspecting whether an aluminum layer is exposed in a pouch cell or a battery module including a plurality of stacked pouch cells, the apparatus comprising:
at least one contact part configured to contact a cut surface of a sealing portion of the pouch cell and be electrically connected to the aluminum layer;
a photon irradiator configured to irradiate photons toward a surface of the pouch cell to induce a photoelectric effect in the aluminum layer when the aluminum layer is exposed; and
a controller including a determination unit configured to read an electrical signal generated when electrons emitted from the aluminum layer by the photoelectric effect are transmitted through the at least one contact part, and determine whether the aluminum layer is exposed based on the read electrical signal.

2. The apparatus of claim 1, wherein the at least one contact part comprises:
at least one contact unit disposed to correspond to the cut surface of the sealing portion; and
an elastic conductive part formed at a front end of each contact unit and electrically connected to the aluminum layer.

3. The apparatus of claim 2, wherein the elastic conductive part comprises:
a conductive rubber elastically contacting the cut surface of the sealing portion;
a contact pin pressed by the conductive rubber to be electrically connected to the aluminum layer; and
a support plate accommodating the conductive rubber and the contact pin, providing a moving space for the conductive rubber and the contact pin, and supporting the conductive rubber and the contact pin.

4. The apparatus of claim 3, wherein the at least one contact unit is connected to a position controller configured to adjust a position and an angle of the elastic conductive part such that the elastic conductive part is oriented in a direction facing the corresponding cut surface of the sealing portion.

5. The apparatus of claim 1, wherein the photon irradiator comprises:
a light source configured to generate photons having an Extreme Ultraviolet (EUV) wavelength; and
a transfer unit configured to transfer the light source along an upper portion of the pouch cell or the battery module.

6. The apparatus of claim 1, wherein the determination unit comprises logic configured to:
read a voltage or current value of the electrical signal transmitted through the at least one contact part; and
determine that the aluminum layer is exposed to the outside when the electrical signal is equal to or greater than a reference threshold.

7. The apparatus of claim 6, wherein the controller is further configured to:
output the read electrical signal to a user interface; and
identify and display a location where exposure of the aluminum layer is suspected.

8. A method for inspecting whether an aluminum layer is exposed in a pouch cell or a battery module including a plurality of stacked pouch cells, the method comprising:
disposing a contact part configured to contact a cut surface of a sealing portion of the pouch cell and be electrically connected to the aluminum layer;
inducing a photoelectric effect in the aluminum layer when the aluminum layer is exposed, by irradiating photons toward a surface of the pouch cell;
reading an electrical signal generated when electrons emitted from the aluminum layer by the photoelectric effect are transmitted through the contact part; and
determining whether the aluminum layer is exposed based on the electrical signal.

9. The method of claim 8, wherein the contact part comprises:
at least one contact unit disposed to correspond to the cut surface of the sealing portion; and
an elastic conductive part formed at a front end of each contact unit and electrically connected to the aluminum layer.

10. The method of claim 9, wherein the elastic conductive part comprises:
a conductive rubber elastically contacting the cut surface of the sealing portion;
a contact pin pressed by the conductive rubber to be electrically connected to the aluminum layer; and
a support plate accommodating and supporting the conductive rubber and the contact pin.

11. The method of claim 10, wherein the at least one contact unit is connected to a position controller configured to adjust a position and an angle of the elastic conductive part such that the elastic conductive part is oriented in a direction facing the cut surface of the sealing portion.

12. The method of claim 8, wherein inducing the photoelectric effect in the aluminum layer comprises:
generating the photons using a light source having an Extreme Ultraviolet (EUV) wavelength; and
transferring the light source along an upper portion of the pouch cell or the battery module using a transfer unit.

13. The method of claim 8, wherein determining whether the aluminum layer is exposed comprises: determining that the aluminum layer is exposed to the outside when the electrical signal is equal to or greater than a reference threshold.
